(19) United States
(12) Patent Application Publication
(10) Pub. No.: US 2025/0341012 A1
(43) Pub. Date: Nov. 6, 2025

(54) A METHOD OF RECOVERING ONE OR MORE METAL SPECIES

(71) Applicant: SALTFOSS ENERGY APS, Copenhagen N (DK)

(72) Inventors: Christina Maj FRØDING, Copenhagen N (DK); Gabriela DURAN KLIE, Dourdan (FR); Daniel COOPER, Copenhagen N (DK); James AMPHLETT, Copenhagen N (DK); Laura VOIGT, Copenhagen N (DK); Jakub Marcin SZYKULA, Søborg (DK)

(21) Appl. No.: 19/128,264

(22) PCT Filed: Nov. 10, 2023
(86) PCT No.: PCT/EP2023/081470

§ 371 Date: May 8, 2025

(30) Foreign Application Priority Data
Nov. 11, 2022 (EP) 22207048.4
Nov. 16, 2022 (DK) PA202270564

(51) Int. Cl. C25C 3/08; C25C 3/30; C25C 3/34; H01M 10/54

(52) U.S. Cl. CPC C25C 3/08; C25C 3/30; C25C 3/34; H01M 10/54

(57) ABSTRACT

The present invention relates to a method of recovering one or more metal species from a raw material, such as waste lithium-ion battery material comprising: providing a molten salt comprising at least one metal hydroxide, providing one or more oxoacidity agents, preferably as a reservoir of one or more oxoacidity agents being in communication with the molten salt, setting the oxoacidity of the molten salt with the one or more oxoacidity agents to an oxoacidity value to dissolve at least one metal species in the molten salt, contacting the raw material with the molten salt, performing at least one of the steps b) and c): b) setting an electrical potential of the molten salt to recover a first metal species to a first metal or first metal oxide, c) adjusting the oxoacidity of the molten salt with the one or more oxoacidity agents to precipitate a first metal oxide, d) optionally performing, for one or more further metal species, the method step a) and/or performing at least one of the method steps b) and c).

### FIELD OF THE INVENTION

The present invention relates to a method of recovering one or more metal species as metals or metal oxides. The metal species such as metals or metal oxides are recovered from raw material like for example a waste lithium-ion battery material.

### BACKGROUND OF THE INVENTION

Extraction of materials such as metals from a raw material are used in many technical fields. The extraction techniques are varied in their technical nature. Pyrometallurgy relies on heating the raw material to convert metal oxides to metals or metal compounds. Roasting the materials involves heating in vacuum or an inert atmosphere to convert metal oxides to a mixed metal alloy containing. Pyrometallurgical methods are energy intensive but require simpler mechanical pre-treatment methods. Hydrometallurgical methods are within aqueous chemistry and extraction techniques are a key element of these methods to recover metals or metal compounds from the raw material. The extractions are conventionally carried out with H₂SO₄ and H₂O₂, or HCl, HNO₃, and organic acids. Thereafter follows precipitation techniques along different routes to selectively recover the metal compounds or a precursor for the desired metal or metal compounds.

The extraction and recovery of metal compounds are done within metal ore processing, waste management, recycling of electronic components, for example recycling lithium-ion batteries.

It is well known to recycle lithium-ion batteries and to recover metals and metal compounds therefrom.

U.S. 20220131204 discloses a method where exhausted lithium-ion batteries are dissolved in a solution for extracting e.g. Co and Ni to produce new cathode material for lithium-ion batteries. Several dissolution solutions are used, and a sulfuric acid is used to leaching crushed waste cathode powder.

Following a separation step, the elements such as Co ions in solution is transferred to an aqueous hydroxide solution to precipitate out less valuable metals as hydroxides. The solution still containing the metals to be recovered is then adjusted with a content of e.g. Co if needed. Then the solution is added Na₂CO₃ to extract a Li-compound and the remaining desired metals are recovered as a composite hydroxide, such as Ni_{1/3}Mn_{1/3}Co_{1/3}O(OH) for sintering in a high-temperature process at 900° C. into a composite oxide as the final product. The process involves several waste streams from the several dissolution and treatment solutions.

The following article discloses the recovery of Co from spent LCO-based batteries: “A Green Electrochemical Process to Recover Co and Li from Spent LiCoO₂-Based Batteries in Molten Salts, ACS Sustainable Chem. Eng. 2019, 7, 13391-13399”. The spent LCO (LiCoO₂) was electrochemically reduced to either CoO or Co under controlled potentials at the cathode, releasing Li₂O into molten salts where the Li₂O combined with CO₂ generated at the carbon anode to produce Li₂CO₃. The molten salt used is a Na₂CO₃₋ K₂CO₃ salt, thus a carbonate-based salt. Li₂O captures and reacts with CO₂ to form Li₂CO₃. There is no mentioning of using molten salts comprising metal hydroxides.

WO 2018/229265 discloses a molten salt nuclear fission reactor (MSR) having a molten metal hydroxide as a moderator salt. The molten moderator salt may comprise a redox-element having a reduction potential larger than that of the material in contact with the molten moderator salt or being a chemical species, e.g. water, which controls the oxoacidity of the molten moderator salt. The object in WO 2018/229265 of using a chemical species that controls the oxoacidity is to minimise the corrosion of the reactor wall material, said material typically comprising a Ni-containing alloy.

### SUMMARY OF THE INVENTION

It was an object of the present invention to provide a method of recovering metal species, such as metals or metal oxides from a raw material using a less energy intensive process compared to conventional processes or obtain higher purities, and with less production of waste, both liquid and gaseous wastes compared to conventional processes.

A further object of the present invention was to provide a simpler process for recovering metal species from waste lithium-ion battery material to be used as feedstock for new lithium-ion batteries and without the production of large volumes of harmful liquid and gaseous waste found in most conventional processes.

In accordance with an aspect of the invention, there is provided a method of recovering one or more metal species from a raw material, such as waste lithium-ion battery material comprising:
providing a molten salt comprising at least one metal hydroxide p1 providing one or more oxoacidity agents, preferably as a reservoir of one or more oxoacidity agents being in communication with the molten salt
a) setting the oxoacidity of the molten salt with the one or more oxoacidity agents to an oxoacidity value to dissolve at least one metal species in the molten salt
contacting the raw material with the molten salt
performing at least one of the steps b) and c):
b) setting an electrical potential of the molten salt to recover a first metal species to a first metal or first metal oxide,
c) adjusting the oxoacidity of the molten salt with the one or more oxoacidity agents to precipitate a first metal oxide,
d) optionally performing, for one or more further metal species, the method step a) and/or performing at least one of the method steps b) and c).

In a further aspect, the present invention relates to

A system for recovering one or more metal species from a raw material, such as a waste lithium-ion battery material, preferably for use in the method as defined above, comprising:
a container comprising a molten salt of at least one metal hydroxide
a reservoir comprising water vapour, said reservoir being in communication with the bottom section of the container and said bottom section comprising a sparger
two or more electrodes in contact with the molten salt of at least one metal hydroxide.

### DETAILED DESCRIPTION

The method of recovering one or more metal species from a raw material, such as waste lithium-ion battery material comprises:
providing a molten salt comprising at least one metal hydroxide
providing one or more oxoacidity agents, preferably as a reservoir of one or more oxoacidity agents being in communication with the molten salt
a) setting the oxoacidity of the molten salt with the one or more oxoacidity agents to an oxoacidity value to dissolve at least one metal species in the molten salt
contacting the raw material with the molten salt
performing at least one of the steps b) and c):
b) setting an electrical potential of the molten salt to recover a first metal species to a first metal or first metal oxide,
c) adjusting the oxoacidity of the molten salt with the one or more oxoacidity agents to precipitate a first metal oxide,
d) optionally performing, for one or more further metal species, the method step a) and/or performing at least one of the method steps b) and c).

In one embodiment the above method is used to recover at least two metal species, such as a first metal species and a second metal species, such as at least three metal species, such as a first metal species, a second metal species and a third metal species.

We find that the provision of a molten salt with at least one metal hydroxide has numerous advantages. The metal hydroxide melt has a certain value of oxoacidity. The various metal compounds of the raw material contacted with the molten hydroxide may dissolve to a large extent or not at this oxoacidity value. A preferential and individual dissolution into metal species may therefore be possible, and this is utilised in the method. By setting or adjusting the oxoacidity by adding an oxoacidity agent such as H₂O to the molten hydroxide salt, a single metal species can be dissolved. The metal species formed may then be further processed to recover the specific free metal from the raw material or to recover oxides of a specific metal. The present inventors have surprisingly found that the metals recovered in this way have a satisfactory purity. The recovered materials provided by embodiments according to the present invention have a degree of purity that enables an optional further processing to obtain a commercially valuable product. An advantage of the invention is the relative ease by which separate metals may be recovered by adjusting the oxoacidity value by adding for example H₂O to the metal hydroxide melt. A metal hydroxide like sodium hydroxide is also a very cheap raw material together with H₂O as an oxoacidity agent so a large-scale process is relatively cheap. It is also possible to recover the metal species as metal oxides instead of metals. An advantage of the invention is that it is relatively easy to choose between the alternatives of recovering a metal species as a metal or as a metal oxide with the same means as mentioned above, said means being the provision of a molten salt of a metal hydroxide and using H₂O as an oxoacidity agent. The method according to the invention is therefore very versatile when deciding which metal species should be recovered from the raw material and as which specific species they should be recovered.

Many raw materials will dissolve in a molten salt of a metal hydroxide given the right combination of temperature of the salt and the oxoacidity value of the salt. An advantage of the method according to the invention is therefore the usefulness for recovering metals and metal oxides from a large number of different raw materials.

The raw material may comprise metal compounds such as metal oxides. When the raw material is contacted with the molten salt of a metal hydroxide and a dissolution of the raw material takes place, then the metal compounds of the raw material forms dissolved metal species, such as ionic metal species.

In one embodiment the metal species is a metal ion.

In one embodiment the metal species is a metal ion associated with oxide ions. An example is a Ni-compound forming NiO₂⁻² comprising Ni²⁺ and two O²⁻.

In one embodiment the metal species is a metal hydroxide, such as a composite hydroxide.

In one embodiment, the molten salt comprises a material for surface promoted recovery for precipitation of the metal species.

A material for surface promoted recovery is a material where the precipitation of a metal species in the molten salt preferentially takes place compared to other materials in contact with the molten salt, said other materials having surfaces being for example the container wall for the molten salt, and electrodes in contact with the molten salt.

In one embodiment, the material for surface promoted recovery for precipitation of the metal species comprises a mesh structure.

The material for surface promoted recovery is preferably a high-surface area material.

The material should have a low corrosivity in the molten salt at the prevailing oxoacidity and electrochemical potential during the precipitation. In one embodiment, the material is selected from the group consisting of Mo and Mo-alloys, Ni and Ni-alloys, Pt, ceramic materials such as alumina.

The dissolved metal species may be recovered as the metal species being a metal or as the metal species being a metal oxide.

In one embodiment the raw material substantially does not comprise metals in their metallic state.

In one embodiment the raw material comprises metals in their metallic state at impurity levels. In one embodiment the raw material comprises metal oxide compounds, such as Co oxide compounds.

In one embodiment, the material is an iron ore material.

The metal species may constitute a major part of the raw material or of a pre-treated raw material to be used in the method according to the invention.

In one embodiment, the raw material or the pre-treated raw material comprises more than 90 wt. %, such as more than 80 wt. %, such as more than 70 wt. %, such as more than 60 wt. % of the raw material or pre-treated raw material, all percentages being on the basis of the total weight of the raw material or pre-treated raw material.

### Waste Lithium-Ion Battery Material

The lithium-ion (secondary) batteries find an abundant use in electronic devices such as mobile phones. These batteries become waste materials as a result of a use and an expiry of the lithium-ion secondary batteries or may have been discarded because of defects or other.

Waste lithium-ion battery materials typically comprises positive electrode materials for lithium-ion (secondary) batteries.

The waste comprises valuable metals such as cobalt and nickel which are commercially attractive to recover in high purity for example for reuse to manufacture new lithium-ion batteries or other purposes. The oxides of cobalt and nickel are also commercially attractive to recover in high purity.

In one embodiment, the waste lithium-ion battery material contains the elements cobalt and nickel as compounds, preferably up to 30 wt. % cobalt and up to 30 wt. % nickel.

A lithium-ion battery typically has a cover or housing made of aluminium serving as an exterior cover for the battery. The electrode material is comprised in the housing. The positive electrode material may comprise single metal oxide or two or more composite metal oxides of the elements lithium, nickel, manganese and cobalt. The positive electrode material may be applied to an aluminium-containing substrate.

There may also be organic compounds present in a waste lithium-ion battery material, such as a polyvinylidene fluoride binder (PVDF) and an organic electrolyte such as carbonates, such as ethylene carbonate and diethyl carbonate.

In one embodiment, the waste lithium-ion battery material is in the form of powder that has been processed. The purpose of the processing is to render the waste lithium-ion battery material suitable for the dissolving in a molten salt comprising at least one metal hydroxide. The processing may be a roasting, such as a roasting to remove organic substances from the waste lithium-ion battery material.

In one embodiment, the waste lithium-ion battery material is pre-treated, such as roasted before the dissolving in a molten salt comprising at least one metal hydroxide.

The roasting involves heating the battery waste, such as heating at a temperature of 450° C. to 1000° C., such as 600° C. to 800° C., for 15 minutes to 5 hours, for example.

In one embodiment, the waste lithium-ion battery material is not roasted before the dissolving in a molten salt comprising at least one metal hydroxide.

This has the advantage of providing a less energy intensive pre-treatment for the waste lithium-ion battery material.

In one embodiment, the raw material is a waste lithium-ion battery material.

In one embodiment, the waste lithium-ion battery material comprises single metal oxide or two or more composite metal oxides of one or more of the elements lithium, nickel, manganese and cobalt.

In one embodiment the waste lithium-ion battery material comprises an electrode material, such as a cathode material.

In one embodiment the raw material comprises one or more waste lithium-ion battery materials based on oxides selected from the group consisting of:

Lithium Nickel Manganese Cobalt Oxide (NMC, LiNiₓMn_{y}CO_{z}O₂),

Lithium Nickel Cobalt Aluminium Oxide (NCA, LiNiCoAlO₂),

Lithium Manganese Oxide (LMO, LiMn₂O₄),

Lithium Iron Phosphate (LFP, LiFePO₄),

Lithium Cobalt Oxide (LCO, LiCoO₂).

### Molten Salt Comprising At Least One Metal Hydroxide

Metal hydroxides like NaOH are cheap chemicals for various chemical processes. The metal hydroxide may be any metal hydroxide as desired, but the metal hydroxide is preferably a hydroxide of an alkali metal, e.g. sodium, potassium, rubidium or lithium hydroxide, or their mixtures, or the metal hydroxide may be a hydroxide of an earth alkaline metal, e.g. calcium or magnesium. Likewise, the metal hydroxide may be hydroxides of different metals.

In one embodiment, the metal hydroxide is one or more hydroxides selected from the group of NaOH, KOH, LiOH and RbOH, such as NaOH.

The temperature of the molten salt should be set above the melting temperature of the salt, at least high enough to ensure that the molten salt will not freeze out. The specific choice of the temperature also depends on the metal species that should be recovered from the raw material. If the raw material comprises several metal species then each of these metal species may in general have associated with them different oxoacidity values where they are dissolved. The differences in oxoacidity values between the various metal species varies with temperature and the differences at one temperature may be larger than at another temperature.

The temperature of the molten salt is preferably in the interval of 100° C.-1300° C., such as 170° C.-1300° C., such as 300° C.-1000° C., such as 350° C.-800° C., such as 400° C.-600° C.

When the molten salt of a metal hydroxide is located in a container, the molten salt of a metal hydroxide may be stationary, or the molten salt of a metal hydroxide may circulate in the container by natural convection, forced convection or forced circulation. In general, forced circulation involves stirring the molten salt of a metal hydroxide. Any kind of stirring may be used in the method. Pumping the molten salt of a metal hydroxide may also be a means of circulating the molten salt. In the present context, natural convection is considered to involve movement in the molten salt of a metal hydroxide occurring due to gradients in temperature and/or concentrations of the components of the molten salt of a metal hydroxide without any active steps being performed to influence the convection. When no active steps are taken to create gradients in temperature and/or concentrations, the molten salt of a metal hydroxide is generally considered stationary in the present context. In contrast, forced convection is considered to involve movement in the molten salt of a metal hydroxide caused by actively introducing gradients in temperature and/or concentrations, especially temperature. For example, localised heating of a volume of the molten salt of a metal hydroxide may cause a localised expansion of the molten salt of a metal hydroxide near a heat source, which causes movements in the molten salt of a metal hydroxide.

Likewise, localised cooling of a volume of the molten salt of a metal hydroxide may cause a localised contraction of the molten salt of a metal hydroxide near a heat sink, which causes movements in the molten salt of a metal hydroxide. Forced convection and forced circulation allow that the oxoacidity in the molten salt of a metal hydroxide is generally uniform. In the present context, forced circulation may be expressed in terms of volumetric replacement over time and have the unit per hour (or h⁻¹), e.g. the volumetric replacement may be in the range of 0.1 h⁻¹ to 100 h⁻¹, e.g. 1 h⁻¹ to 20 h⁻¹.

### Oxoacidity Agent

Molten salts may comprise water and other components, which will contribute to define the property “oxoacidity” of the molten salt. In molten salts containing hydroxides, the hydroxide ion is an amphoteric species, which can accept a proton to become H₂O as well as donate a proton to become the oxide ion O²⁻. Water present in the molten salt reacts by Equation 2

$$2 {H}_{2} O ⇄ {H}_{3} {O}^{+} + {OH}^{-} \qquad Equation 1$$

$$2 {OH}^{-} ⇄ {H}_{2} O + {O}^{2 -} \qquad Equation 2$$

In the present context, we define the oxoacidity as pH₂O=−log₁₀[H₂O] and the oxobasicity is pO²⁻=−log₁₀[O²⁻], in analogy with the well-known definition of PH=−log₁₀[H⁺] and pOH=−log₁₀[OH⁻] in aqueous phase chemistry.

The unitless quantity paH₂O may also be used to characterise the oxoacidity of the molten salt of a metal hydroxide, where “a” denotes the activity of H₂O. Both pH₂O and paH₂O will be used in the following.

In one embodiment, the temperature of the molten salt of a metal hydroxide is chosen such that the oxoacidity for the dissolution of a first metal compound is different from the oxoacidity for the dissolution of a second metal compound, the oxoacidity difference between the first and second metal compound being in the interval of pa[H₂O]=0.1-2.0, such as pa[H₂O]=0.2-1.5, pa[H₂O]=0.3-1.1, or pa[H₂O]=0.4-0.8.

In the present context, the oxoacidity agent may be any chemical entity, e.g. an element, a molecule or an ion, that can influence the concentration of at least one of OH⁻, O²⁻, and H₂O in a molten salt, especially a molten salt of a metal hydroxide. The influence on the concentration of the at least one of OH⁻, O²⁻, and H₂O may be direct or indirect, and the influence may involve increasing or decreasing the concentration, e.g. according to Equation 2.

In one embodiment, the oxoacidity agent is one or more compounds selected from the group of OH⁻, O²⁻, and H₂O, such as H₂O.

In particular, all of OH⁻, O²⁻, and H₂O are considered oxoacidity agents in the context of the present method, and likewise, molecules including OH⁻ or O²⁻ and appropriate counter ions are also considered oxoacidity agents. Water, H₂O, in particular in vapour form, is a preferred oxoacidity agent. Water, H₂O, may also exist as hydrates in salts or crystals, and salts containing water hydrates may also be used as oxoacidity agents. When a salt contains water hydrates, the number of water molecules in the salt is normally denoted “·xH₂O” together with the stoichiometric composition of the salt, and the value of x may be employed to determine the amount of the salt to adjust the oxoacidity. Other oxoacidity agents are metal oxide salts, e.g. oxide salts of the same metal as the metal of the molten salt of a metal hydroxide. Molecules capable of binding with or donating OH⁻, O²⁻, and/or H₂O are also considered oxoacidity agents in the present context.

An oxoacidity agent may be present in a metal hydroxide before the salt is molten, and thereby the oxoacidity agent will also be present in the metal hydroxide salt once molten. However, due to the high temperature typically used for melting the salt and due to possible reactions between the oxoacidity agent and other components causing changes in the equilibrium, the content of the oxoacidity agent will not be a constant over time. For example, the oxoacidity agent may evaporate from the molten salt.

A reservoir comprising one or more oxoacidity agents provides a means for supplying oxoacidity agents to a molten salt comprising at least one metal hydroxide.

The reservoir may be any kind of container, piping or tubing. The communication or interface between the molten salt and the one or more oxoacidity agents in the reservoir may be with any kind of container, piping or tubing.

In one embodiment, the reservoir comprises a processing gas comprising an oxoacidity agent. The processing gas is brought into contact with the molten salt of a metal hydroxide. Thereby, the oxoacidity agent is also brought into contact with the molten salt of a metal hydroxide, and the oxoacidity of the molten salt of a metal hydroxide can be adjusted. In general, the amount of oxoacidity agent brought into contact with the molten salt of a metal hydroxide is determined by the concentration of the oxoacidity agent in the processing gas, the pressure of the processing gas and the amount of processing gas, e.g. expressed as unit of volume per unit of time, such as m³/min, brought into contact with the molten salt of a metal hydroxide. The processing gas may comprise argon or nitrogen. The amount of oxoacidity agent relevant for a specific example of the method is determined by the estimate(s) of the concentrations of the at least one of OH⁻, O²⁻, and H₂O in a molten salt of a metal hydroxide and the chemical reaction equilibrium between the chosen oxoacidity agent and one or more of OH⁻, O²⁻, and H₂O present in the molten salt of a metal hydroxide.

When the gas contains the oxoacidity agent, the gas may be bubbled through the molten salt of a metal hydroxide by means of a sparger.

When the gas contains the oxoacidity agent, the volume of gas bubbled through the molten salt of a metal hydroxide takes into account the intended amount of oxoacidity agent to be brought into contact with the molten salt of a metal hydroxide, and the amount of gas bubbled through the molten salt of a metal hydroxide may be expressed in the volume of inert gas relative to the volume of molten salt of a metal hydroxide per unit of time, so that the unit may be per hour (or h⁻¹). The volume of inert gas bubbled through the volume of molten salt of a metal hydroxide may be in the range of 0.1 h⁻¹ to 10 h⁻¹, e.g. 0.5 h⁻¹ to 2 h⁻¹. When a gas is bubbled through the molten salt of a metal hydroxide, the bubbles may create a forced circulation of the molten salt of a metal hydroxide, especially when the volume of gas bubbled through the volume of molten salt of a metal hydroxide is above 2 h⁻¹.

In one embodiment, a gas is bubbled through the molten salt of a metal hydroxide, the gas being an inert gas, i.e. an inert gas not containing the oxoacidity agent, a processing gas with the oxoacidity agent, or the oxoacidity agent in a gaseous form.

In one embodiment, a processing gas comprising the oxoacidity agent is in contact with the molten salt of a metal hydroxide,

The oxoacidity agents may also be added to the molten salt of a metal hydroxide without the use of a processing gas. For example, solid metal oxide like lithium or sodium oxide can be added in the form of solid pellets into the molten salt in suitable quantities to achieve the target concentration of any of OH⁻, O²⁻, and H₂O in a molten salt of a metal hydroxide. In another example, molten potassium hydroxide hexahydrate can be titrated into the molten salt of a metal hydroxide, to achieve the target concentration of any one of OH⁻, O²⁻, and H₂O. It is also possible to contact oxides, e.g. Li₂O or Na₂O, with the molten salt of a metal hydroxide.

The oxoacidity may be expressed for one of OH⁻, O²⁻, and H₂O, or the oxoacidity may be expressed for a combination of two or all three of OH⁻, O²⁻, and H₂O. OH⁻, O²⁻, and H₂O contribute to the oxoacidity and by estimating the oxoacidity of one, two or all three of OH⁻, O²⁻, and H₂O, together with contacting the molten salt of a metal hydroxide with the processing gas comprising the oxoacidity agent, the oxoacidity of the molten salt of the metal hydroxide can be adjusted and/or set, e.g. in accordance with Henry's law, to be within the wanted range of oxoacidity values. In general, it is assumed that the amount of oxoacidity agent dissolved in the molten salt of a metal hydroxide when the oxoacidity agent is provided in a gaseous form is proportional to the partial pressure of the oxoacidity agent brought in contact with, e.g. by being above, the molten salt of a metal hydroxide.

### Setting or Adjusting the Oxoacidity of the Molten Salt

The metal species of the raw material will be present in the molten salt of at least one hydroxide in a given phase out of a number of possible phases for the metal species. The phase that is prevailing for a first metal compound is given by the temperature and composition of the molten salt of the hydroxide and the redox potential and the oxoacidity value for the molten salt of the hydroxide.

In order to set or adjust the oxoacidity value of the molten salt to recover a metal species in a phase of preference for example in a metallic state, it is possible to know the oxoacidity value in a first estimate from a calculation of a diagram of Equilibrium redox potential vs. oxoacidity (for example E vs. p(H₂O)). Such a diagram will show the phases for the chosen metal compound at a given oxoacidity value.

The oxoacidity value of the molten salt is thereafter set/adjusted following the diagram with the aim in mind such as the aim of dissolving the raw material or precipitating a metal species as a metal oxide.

The construction of the E vs. p(H₂O) diagrams follows from thermodynamic data. The basic steps for the construction of the thermodynamic diagrams are described in the following:

All equilibrium reactions between the different chemical species of a same element are considered. The Na⁺/Na redox couple is chosen as the reference system for the choice of NaOH as the molten salt of a metal hydroxide.

Thermodynamic data for a pure substance is used to calculate the Gibbs free energy and the equilibrium constants for all equilibrium reactions. Thermodynamic data can be calculated using for example HSC chemistry 6.0 software or obtained experimentally.

Equilibrium redox potentials, for all equilibrium reactions proposed, is then calculated by the accompanying Nernst equation.

The resulting diagrams at 350° C. following such procedure for a NaOH molten salt and a raw material comprising Mn-oxides, Ni-oxides and Co-oxides is seen in FIG. 1a, FIG. 1b and FIG. 1c, respectively.

The metal species may in some of the phases be present as metal species being a metal ion associated with oxide ions. For example, Ni may be present in a phase as NiO₂⁻² comprising Ni²⁺ and two O₂₋. In other phases the metal species may be a metal ion.

The oxoacidity may be set/adjusted in the molten salt by using the relation between the water partial pressure in a gas in a reservoir comprising oxoacidity agents, said reservoir being in communication with the molten salt.

The oxoacidity values obtained from the calculated E vs. p(H₂O) diagrams may in most cases be supplemented with data from electrochemical experiments. The diagrams and their applicability may be limited by the thermodynamic data available in the database. So, chemical and electrochemical experiments are normally required to complete and verify the validity of the thermodynamic diagrams.

By way of illustration, the following electrochemical experiments may be suited for the combination of a Co-oxide in a molten hydroxide salt: after the evaluation of the thermodynamic data for a raw material in molten hydroxide, the redox and chemical equilibria of the selected material is established. Two chemical species forming a redox couple (e.g Co(III)/Co(II) or Co(II)/Co) are introduced into the melt with a known concentration. The ratio of the redox couple fixes the equilibrium potential of the molten hydroxide salt. Open circuit potential measurements are recorded at different oxoacidity conditions.

In one embodiment the oxoacidity is set to a value of the parameter pa (H₂O).

In one embodiment the oxoacidity is adjusted to a value of the parameter pa (H₂O).

The setting or the adjustment of the oxoacidity, for example to a value of the parameter pa (H₂O) may be carried out with the same means, such as the means to provide an oxoacidity agent to the molten salt of a metal hydroxide.

In one embodiment, the oxoacidity of the molten salt is set with the one or more oxoacidity agents to a value to dissolve the raw material to metal species in the molten salt and then the raw material is contacted with the molten salt.

The oxoacidity value is thus set to a value where it will dissolve a raw material comprising one or more metal species and then the raw material comprising metal species is contacted with the molten salt.

This embodiment of the invention where the molten salt is prepared before contact with the raw material has the advantage that the dissolution reactions will take place from the start with the oxoacidity value devised from E vs. oxoacidity diagrams and electrochemical tests.

In one embodiment, the raw material is contacted with the molten salt and then the oxoacidity of the molten salt is set with the one or more oxoacidity agents to a value to dissolve a raw material to metal species in the molten salt.

The oxoacidity value is thus set to a value where it will dissolve a first metal compound while the raw material comprising a metal species is contacted with the molten salt and present in the molten salt.

This embodiment of the invention where the raw material is in contact with the molten salt during the adjustment of the oxoacidity value of the molten salt has the advantage that the dissolution reactions will take place from the start upon contact. Any lengthy adjustments of the oxoacidity value before the dissolution can take place is thereby avoided. The dissolution of a raw material comprising metal compounds may still take place to some extent even though a devised oxoacidity value has not yet been reached by the adjustment.

In one embodiment, the oxoacidity is adjusted during the process of dissolving a raw material.

In one embodiment, the oxoacidity is adjusted during the process of electroplating a metal or metal oxide from a metal species.

In one embodiment, the oxoacidity is adjusted with a hydrogen gas during the process of electroplating a metal or metal oxide from a metal species.

In one embodiment, the oxoacidity is adjusted during the process of precipitation of a metal oxide from a metal species.

In one embodiment, the method of recovering one or more metal species from a raw material, such as waste lithium-ion battery material comprises:
providing a molten salt comprising at least one metal hydroxide
providing one or more oxoacidity agents, preferably as a reservoir of one or more oxoacidity agents being in communication with the molten salt
a) setting the oxoacidity of the molten salt with the one or more oxoacidity agents to an oxoacidity value to dissolve at least one metal species in the molten salt
contacting the raw material with the molten salt
performing at least one of the steps b) and c):
b) setting an electrical potential of the molten salt to recover a first metal species to a first metal or first metal oxide,
c) adjusting the oxoacidity of the molten salt with the one or more oxoacidity agents to precipitate a first metal or first metal oxide,
d) optionally performing, for one or more further metal species, the method step a) and performing at least one of the method steps b) and c).

In one embodiment, the method of recovering one or more metal species from a raw material, such as waste lithium-ion battery material comprises:
providing a molten salt comprising at least one metal hydroxide
providing one or more oxoacidity agents, preferably as a reservoir of one or more oxoacidity agents being in communication with the molten salt
a) setting the oxoacidity of the molten salt with the one or more oxoacidity agents to an oxoacidity value to dissolve at least one metal species in the molten salt
contacting the raw material with the molten salt
performing at least one of the steps b) and c):
b) setting an electrical potential of the molten salt to recover a first metal species to a first metal or first metal oxide,
c) adjusting the oxoacidity of the molten salt with the one or more oxoacidity agents to precipitate a first metal or first metal oxide,
d) optionally performing, for one or more further metal species, the method step a) or performing at least one of the method steps b) and c).

In one embodiment, the method of recovering one or more metal species from a raw material, such as waste lithium-ion battery material comprises:
providing a molten salt comprising at least one metal hydroxide
providing one or more oxoacidity agents, preferably as a reservoir of one or more oxoacidity agents being in communication with the molten salt
a) setting the oxoacidity of the molten salt with the one or more oxoacidity agents to an oxoacidity value to dissolve at least one metal species in the molten salt
contacting the raw material with the molten salt
performing at least one of the steps b) and c):
b) setting an electrical potential of the molten salt to recover a first metal species to a first metal or first metal oxide,
c) adjusting the oxoacidity of the molten salt with the one or more oxoacidity agents to precipitate a first metal or first metal oxide,
d) optionally performing, for one or more further metal species, the method step a) and/or performing at least one of the method steps b) and c).

In one embodiment, a waste lithium-ion battery material comprising metal species is contacted with the molten salt. The oxoacidity is set to dissolve the raw material into a first metal species;

an electrical potential is applied to reduce the first metal species to a first metal, thereafter the oxoacidity is set to dissolve the raw material into a second metal species; an electrical potential is applied to reduce the second metal species to a second metal, and preferably thereafter the oxoacidity is set to dissolve the raw material into a third metal species; an electrical potential is applied to reduce the third metal species to a third metal.

The above mentioned three metal species have preferred values of oxoacidity for dissolving them respectively. For example, the oxoacidity value pa[H₂O] for the first metal species <pa[H₂O] for the second metal species <pa[H₂O] for the third metal species.

An advantage of this embodiment of the invention is that the metals may be recovered individually as substantially pure metals. Another advantage is that the recovery of a metal species may be done for only one or only two or all three of the three metal species thereby showing the versatility of the method. This principle and the versatility apply analogously to the case where the raw material comprises two metal species and to the cases where the raw material comprises three or more metal species.

In the above embodiment the first metal may be Mn and the one or more further metals may be selected from the group consisting of Al and transition metals, such as Fe, Co, Ni.

In one embodiment, waste lithium-ion battery material comprising Mn-, Ni- and Co-oxides are contacted with the molten salt.

The oxoacidity is set to dissolve the raw material into a Mn species;

an electrical potential is applied to reduce the Mn species to Mn, preferably thereafter the oxoacidity is set to dissolve the raw material into a Ni species;

an electrical potential is applied to reduce the Ni species to Ni, and preferably thereafter the oxoacidity is set to dissolve the metal compound into a Co species;

an electrical potential is applied to reduce the Co species to Co.

An advantage of this embodiment of the invention is that the separation of Ni and Co is achieved to their respectively substantially pure metallic forms in a one-pot process. This is difficult to achieve with most processes known hitherto.

In one embodiment, the oxoacidity is set to dissolve a raw material into a first, a second and a third metal species,

the oxoacidity is adjusted to precipitate the first metal species as a first metal oxide, preferably thereafter the oxoacidity is adjusted to precipitate the second metal species as a second metal oxide, and preferably thereafter the oxoacidity is adjusted to precipitate the third metal species as a third metal oxide.

The above mentioned three metal species have different values of oxoacidity for dissolving them respectively and the oxoacidity is set to dissolve all of them. Thereafter, their differences in oxoacidity are utilised to precipitate out the metal oxides consecutively.

An advantage of this embodiment is that it is possible to obtain the metal species in their substantially pure oxide form and furthermore that this is done in a one-pot process.

In the above embodiment, the first metal species is a Co species and the one or more further metal species may be transition metal species, such as transition metal species selected from the group of Fe, Mn, Ni.

In one embodiment, waste lithium-ion battery material comprising Mn-, Ni- and Co-oxides are contacted with a molten salt. The oxoacidity is set to dissolve all oxides. Thereafter, the oxoacidity is adjusted to precipitate the Co species as a Co oxide, preferably thereafter the oxoacidity is adjusted to precipitate the Ni species as a Ni oxide, and preferably thereafter the oxoacidity is adjusted to precipitate the Mn species as a Mn oxide.

In one embodiment, waste lithium-ion battery material is contacted with the molten salt. The oxoacidity is set to dissolve the raw material into a first metal species; an electrical potential is applied to reduce the first metal species to a first metal, preferably thereafter the oxoacidity is set to dissolve a second and a third metal species and the oxoacidity is adjusted to precipitate the second metal species as a second metal oxide, preferably thereafter an electrical potential is applied to reduce the third metal species to a third metal.

An advantage of this embodiment of the invention is that the recovery of a metal species can be chosen to be as a metal and other metal species can be chosen to be recovered as their respective oxides thus showing the versatility of the method.

In one embodiment, waste lithium-ion battery material comprising Mn-, Ni- and Co-oxides are contacted with a molten salt. The oxoacidity is set to dissolve the raw material into a Mn species; an electrical potential is applied to reduce the Mn species to Mn, preferably thereafter the oxoacidity is set to dissolve the raw material into a Co species and the oxoacidity is adjusted to precipitate the Co species as a Co oxide, preferably thereafter an electrical potential is applied to reduce the Ni species to Ni.

In one embodiment, the dissolving is done in part as an electrochemical reducing dissolution.

In one embodiment, the dissolving is not done fully or in part as an electrochemical dissolution.

In one embodiment, the electrical potential of the molten salt is set by setting the electrical potential using a redox agent, and/or setting the electrical potential with an applied voltage between an anode and a cathode in the molten salt, said step of setting the electrical potential is carried out after contacting the raw material with the molten salt.

In one embodiment, the electrical potential of the molten salt is set by setting the electrical potential using a redox agent, or setting the electrical potential with an applied voltage between an anode and a cathode in the molten salt, said step of setting the electrical potential is carried out after contacting the raw material with the molten salt.

In one embodiment the redox agent is selected from a list of H₂, alkaline metals, such as Mg, Be, and Ca; alkali metals, O₂.

In one embodiment, the electrical potential of the molten salt is set by setting the electrical potential using a redox agent being an H₂ containing gas in contact with the molten salt.

The H₂ containing gas may contain 1-20 vol. % H₂, such as 2-17 vol. % H₂, such as 3-15 vol. % H₂, such as 4-10 vol. % H₂, the remainder being an inert gas such as Ar or N₂.

In one embodiment, the electrical potential of the molten salt is set by setting the electrical potential using a redox agent being an H₂ containing gas in contact with the molten salt and the electrical potential is lowered with a voltage in the interval from 0.05 to 0.75 V, such as in the interval from 0.10 to 0.4 V, such as in the interval from 0.15 to 0.3 V.

The molten salt may after contact with the raw material have a redox potential where more than one metal species of the same metal is present for the same oxoacidity value. In this case, the redox material may be set to discriminate between the one or more other metal species of the same metal that are present in the molten salt. For example, a higher redox potential value may favour the presence of a more oxidised phase of the metal species over a less oxidised phase.

In one embodiment, the oxoacidity and the redox potential is set so substantially one phase of the metal species is present.

In one embodiment, the oxoacidity and the redox potential is set so two phases of the metal species are present.

The presence of two different metal species of the same metal may be aimed at intentionally depending on the purpose of the metal species recovery.

The recovery of two metal species of the same metal where one of the species form a minor constituent of the recovered composite metal species may form the basis as a raw material for further metal/metal oxide recovery processes. The advantage is that the raw material contains only very few species for the further processing with the simple process of the invention.

In one embodiment, the concentration of the dissolved one or more metal species is in the interval of 0.1 to 10 mol/kg molten salt, such as 0.2 to 7 mol/kg molten salt, such as 0.4 to 5 mol/kg molten salt, such as 0.8 to 3 mol/kg molten salt.

### Applying an Electrical Potential

In one embodiment, the electrical potential applied to recover the first metal species as a first metal, or first metal oxide is carried out in an electrodeposition process comprising:
applying the electrical potential to two or more electrodes submerged in the molten salt of a metal hydroxide comprising the metal species,
the first metal or first metal oxide being deposited and recovered from the electrode forming the cathode.

An electrical potential can be applied between electrodes, in a two or more electrode system, submerged in the molten hydroxide solvent containing dissolved metal species resulting in the deposition of one or more metal species onto the cathode. This process is commonly called electroplating, electrochemical deposition, or electrodeposition. The electrical potential can be selected based on the target dissolved metal species and/or the target electroplated material. The selection of relevant potentials is done through the calculation and subsequent verification of thermodynamic diagrams as described below. The selected potential is applied through use of equipment such as potentiostats and galvanostats.

In one embodiment, the oxoacidity during dissolution is set to dissolve a Co-compound from a cathode material of a waste lithium-ion battery material, and a potential is applied to recover it as metallic cobalt. Choice of potential will depend on the oxoacidity, and an example range could be 0.5-1 V.

In another embodiment, a Mn-compound is dissolved from a cathode material, of a waste lithium-ion battery material, a potential is applied to electrodeposit it as an oxide. An example of the potential range for this could be 1.75-2.2 V.

In an example, where both Mn and Ni are dissolved from cathode material of a waste lithium-ion battery material, this allows for the separation of the two elements based on the applied potential. For example, if the oxoacidity is fixed correctly, then Ni species could first be electrodeposited as Ni metal onto a cathode, the cathode could then be replaced, and a different potential applied to electrodeposit the Mn species as an oxide, thus effecting a selective separation. Example potential ranges for this could be first 1-1.4 V, and second 1.5-2 V.

A change in the oxoacidity or the redox potential of the hydroxide melt can cause the dissolved metal species to form non-ionic oxide compounds. These oxides have low solubility in the molten hydroxide, much lower than the ionic species produced during raw material dissolution, thus causing them to form a solid and precipitate from the melt as metal oxides.

A flow diagram illustrating an embodiment of the invention will be described in the following with reference to FIG. 2.

The raw material was a waste lithium-ion battery material comprising at least three metal oxides, such as in a combined oxide.

The metal compounds were identified in the raw material. This is illustrated in the flow diagram of FIG. 2 with reference (1).

The potential vs. oxoacidity diagrams, one for each metal compound and denoted (2) in FIG. 2 followed from thermodynamic data and calculations of equilibrium constants for all involved equilibrium reactions. Potentiometric measurements were also carried out to establish the diagrams. Also, the potential vs. oxoacidity diagram for the used metal hydroxide was established. NaOH was chosen in this embodiment.

The oxoacidity diagrams denoted (2) in FIG. 2, provided the further input (3) to the next step (4) of predefining the process steps for recovering the wanted metal species.

If the aim was to recover three metal species in their respective metallic state, then the oxoacidity was set/adjusted to a value where a first metal exists as a first metal ion in the potential vs. oxoacidity diagram. A range of oxoacidity values exists for this criterion and a value in this range was chosen where the metal in question was the only metal that exists as a metal ion. The first metal oxides thereafter dissolved at this oxoacidity value as denoted (5) in FIG. 2. The first metal was recovered from the dissolved first metal ion by electroplating, denoted (6) in FIG. 2. Process steps (5) and (6) were repeated for the second metal species and then the third metal species until all three metal species were recovered in their respective metallic state.

### The System for Recovering One or More Metal Species

In one embodiment, the system for recovering one or more metal species from a raw material, such as a waste lithium-ion battery material, preferably for use in the method stated above, comprises:
a container comprising a molten salt of at least one metal hydroxide
a reservoir comprising a water vapour, said reservoir being in communication with the bottom section of the container and said bottom section comprising a sparger
two or more electrodes in contact with the molten salt of at least one metal hydroxide.

The raw material may be any of the raw materials disclosed in the aspect of the invention of a method of recovering one or more metal compounds from a raw material, such as a waste lithium-ion battery material.

In one embodiment, the raw material is a waste lithium-ion battery material. In one embodiment, the features of the method stated above may be used for the system of recovering one or more metal species from a raw material, such as a waste lithium-ion battery material.

The molten salt comprising a metal hydroxide is preferably located in a container.

In one embodiment, the metal hydroxide is one or more hydroxides selected from the group consisting of NaOH, KOH, LiOH and RbOH, such as NaOH.

The container may be made from any material, e.g. a metal, a metal alloy, a ceramic material or a combination thereof, and in the present context this material is referred to as the container material. The inner surface may be a surface of the container material so that a lining material is the container material, or the container material may be coated with a further material thus providing a lining material. For example, the container material may be a metal alloy, e.g. a nickel-based alloy, a nickel-based superalloy or a Hastelloy, or nickel. In the present context, a nickel-based alloy is an alloy having at least 50 w. % nickel.

In one embodiment, the container comprises polytetrafluoroethylene, such as a liner of polytetrafluoroethylene.

In one embodiment, the container and/or the inner surface of the container comprises a ceramic material.

The container may have any size and shape as desired. Exemplary container volumes are in the range of 1 m³ to 10 m³.

In one embodiment, the container comprises means for forced circulation of the molten salt.

When the molten salt of a metal hydroxide is in a container, the molten salt of a metal hydroxide may be stationary, or the molten salt of a metal hydroxide may circulate in the container by natural convection, forced convection or forced circulation.

In general, the means for forced circulation may be stirring the molten salt of a metal hydroxide. Any kind of stirring means may be used.

In the present context, natural convection is considered to involve movement in the molten salt of a metal hydroxide occurring due to gradients in temperature and/or concentrations of the components of the molten salt of a metal hydroxide without any active steps being performed to influence the convection. When no active steps are taken to create gradients in temperature and/or concentrations, the molten salt of a metal hydroxide is generally considered stationary in the present context. In contrast, forced convection is considered to involve movement in the molten salt of a metal hydroxide caused by actively introducing gradients in temperature and/or concentrations, especially temperature.

In one embodiment, the container comprises means for localised heating of the molten salt.

The localised heating of a volume of the molten salt of a metal hydroxide may cause a localised expansion of the molten salt of a metal hydroxide near a heat source, which causes movements in the molten salt of a metal hydroxide. Likewise, localised cooling of a volume of the molten salt of a metal hydroxide may cause a localised contraction of the molten salt of a metal hydroxide near a heat sink, which causes movements in the molten salt of a metal hydroxide. Forced convection and forced circulation allow that the oxoacidity in the molten salt of a metal hydroxide is generally uniform. In the present context, forced circulation may be expressed in terms of volumetric replacement over time and have the unit per hour (or h¹), e.g. the volumetric replacement may be in the range of 0.1 h¹ to 100 h¹, e.g. 1 h¹ to 20 h¹.

In one embodiment, the container comprises a cover gas above the molten salt of a metal hydroxide,

In one embodiment, the container has a lid covering the molten salt of a metal hydroxide to provide a closed system.

The lid may also have openings to control the composition and the pressure of the cover gas. The cover gas may be maintained at a pressure above ambient pressure, e.g. at a pressure in the range of 1 bar to 10 bar.

The container comprises heating means for heating the salt of a metal hydroxide.

In one embodiment, the container comprises a heating element and insulation to maintain the desired temperature in the container throughout the process of recovering one or more metal compounds.

The container may comprise a funnel at the upper section of the container to provide a means to supply the raw material to the molten salt of the metal hydroxide.

In one embodiment, the system comprises an inventory of cathodes.

The system may also comprise a crane. The crane will lift the one or more cathodes with the electrodeposited metal species out of the molten salt after electrodeposition and lift a cathode from an inventory of unused cathodes into the molten salt.

The system comprises a reservoir comprising a water vapour, said reservoir being in communication with the bottom section of the container.

The reservoir has the purpose of preparing and supplying the processing gas comprising the oxoacidity agent, such as the water vapour.

In one embodiment, the reservoir comprises a vessel containing water. The water may be heated by a heat jacket controlled by a temperature transmitter.

In one embodiment, the system comprises a sparger, preferably comprised in a bottom section of the container.

The sparger provides means for supplying the water vapour from the reservoir into the molten salt of a metal hydroxide. The means may be inlet holes whereby a gas, such as a processing gas comprising water vapour is bubbled through the molten salt.

The use of a sparger ensures a mixing of the raw material in the molten salt alongside a consistent oxoacidity value throughout the molten salt.

In one embodiment, the sparger is adapted to sparging a gas comprising an oxoacidity agent such as a water vapour.

The gas may for example contain water vapour as the oxoacidity agent at a partial pressure in the range of 0.01 bar to 2 bar, e.g. 0.02 bar to 0.5 bar.

In one embodiment, the sparger is adapted to sparging a gas comprising a redox agent.

In one embodiment, the processing gas comprises a redox agent, such as H₂.

In one embodiment, the system comprises an off-gas system comprising an off-gas line between the container and the reservoir. The off-gas line will remove the sparged gas from the container and transport it to the reservoir.

In one embodiment, the off-gas system comprises means for controlling the pressure in the container.

In one embodiment, the processing gas leading into the reservoir may be fed from the off-gas system.

In one embodiment, inlet and outlet humidity transmitters are provided on the gas lines, such as the off-gas line to and from the container.

In one embodiment, a pressure reservoir is in communication with the off-gas line.

The pressure reservoir will provide a back-up in case of loss of flow from the container to the reservoir.

The oxoacidity agent such as the water vapour is recirculated from the container to the reservoir, and the content of the oxoacidity agent may be replenished in the processing gas. The replenishment may be done by providing water or water vapour. For example, the oxoacidity agent may be added directly to the processing gas, which may then be bubbled through the molten salt of a metal hydroxide by means of the sparger. By using the processing gas containing the oxoacidity agent and bubbling the processing gas through the molten salt of a metal hydroxide to recirculate the processing gas, a setup is created where it is easy to control the oxoacidity of the molten salt of a metal hydroxide.

On the inlet and outlet gas lines to the container, there may be humidity transmitters feeding a control system in the reservoir.

In one embodiment, the system comprises a salt handling system.

The salt handling system has the purpose of preparing the salt prior to entering the container. the salt handling system is supplied with one or more salts of a metal hydroxide and melts the salt and transfers the salt to the container. The salt handling system comprises a heating element, insulation and may comprise one or more temperature transmitters and controllers for adjusting the temperature of the molten salt.

The salt handling system may provide means for receiving molten salt from the container. The salt handling system may provide a means for storing the molten salt, such as storing the salt upon the end of the process of recovering one or more metal species.

In one embodiment, two or more electrodes are in contact with the molten salt of at least one metal hydroxide in the container.

In one embodiment, the reservoir comprises a cover gas above the molten salt of a metal hydroxide,

In one embodiment, the container may have a lid covering the molten salt of a metal hydroxide to provide a closed system.

The lid may also have openings to control the composition and the pressure of the cover gas. The cover gas may be maintained at a pressure above ambient pressure, e.g. at a pressure in the range of 1 bar to 10 bar.

In one embodiment there is provided a use of a reservoir comprising one or more oxoacidity agents being in communication with a molten salt comprising at least one metal hydroxide and a raw material comprising metal compounds for recovering at least one metal and/or at least one metal oxide from the metal compounds.

### BRIEF DESCRIPTION OF THE DRAWINGS

In the following the invention will be explained in greater detail with the aid of examples and with reference to the schematic drawings, in which

FIG. 1a shows an overlay of the oxoacidity diagrams of Mn and NaOH;

FIG. 1b shows an overlay of the oxoacidity diagrams of Ni and NaOH;

FIG. 1c shows an overlay of the oxoacidity diagrams of Co and NaOH.

FIG. 2 shows a flow diagram illustrating an embodiment of the invention.

FIG. 3 shows a system for performing embodiments of the method according to the invention.

FIG. 4a shows a Cyclic voltammogram for Co.

FIG. 4b shows a Cyclic voltammogram for Co.

FIG. 5 shows two Cyclic voltammograms for Co recorded on Ni at two different oxoacidities

FIG. 6 shows a SEM of deposited Co.

FIG. 7 shows a SEM of deposited MnO.

FIG. 8 shows a SEM of deposited NiCoO.

FIG. 9 shows a SEM of deposited NiCoMnO

FIG. 10 shows Cyclic voltammograms for NMC in molten NaOH, wet atmosphere;

FIG. 11 shows a Cyclic voltammogram for Ni;

FIG. 12 shows a SEM of deposited Ni;

FIG. 13 shows a change in Open Circuit Potential and concentration of nickel;

FIG. 14 shows an overlay of the oxoacidity diagrams of Fe and NaOH;

FIG. 15 shows a Cyclic voltammogram for Fe;

FIG. 16 shows a change in Open Circuit Potential and concentration of iron.

The invention is not limited to the embodiment/s illustrated in the drawings. Accordingly, it should be understood that where features mentioned in the appended claims are followed by reference signs, such signs are included solely for the purpose of enhancing the intelligibility of the claims and are in no way limiting on the scope of the claims.

The term “comprising” as used in this specification and claims means “consisting at least in part of”. When interpreting statements in this specification and claims which include the term “comprising”, other features besides the features prefaced by this term in each statement can also be present. Related terms such as “comprise” and “comprised” are to be interpreted in a similar manner.

### DETAILED DESCRIPTION

The method will now be illustrated in the following non-limiting examples.

A system (1) for recovering one or more metal compounds is seen FIG. 3. The system (1) comprises a container (2) with a liner material of a ceramic material. The container (2) holds a molten salt (3) of NaOH or another metal hydroxide. The container (2) is in communication with a salt handling system (not shown) for e.g. preparing the salt. A cathode (4) is partly submerged in the molten salt and the cathode (4) forms part of an electrodeposition setup not shown comprising one or more other electrodes for the electrodeposition. The cathode (4) may be replaced with another cathode from an inventory (5) of cathodes following electrodeposition. The replacement of the cathode may be carried out with a crane (6) that lifts the cathode with the electrodeposited metal compound out of the molten salt after electrodeposition and lifts a cathode from the inventory into the molten salt. The raw material comprising the metal compounds to be recovered is provided via a funnel (7) into the molten salt (3).

The bottom section (8) of the container (2) is provided with a sparger (not shown) and the sparger is interfacing with a reservoir (9) for humidified carrier gas. The reservoir (9) contains water (10) and water vapour (11) and is provided with a heating jacket for heating the water. The water vapour is led through piping outlet to the sparger in the bottom section of the container. A water inlet (12) in communication with the reservoir replenishes water to the reservoir as water gas is led out of the reservoir to the container during the processing of the raw material.

The off-gases from the upper section of the container (3) are led via an off-gas line (13) to the reservoir (9).

### EXAMPLE 1

In this example the recovery of °metallic Co is shown. The chosen material to recover Co from was Cobalt Oxide as supplied from Sigma-Aldrich in a purity of 99.8%. The hydroxide used in the process was NaOH supplied by Fisher Scientific in a purity higher than 98%

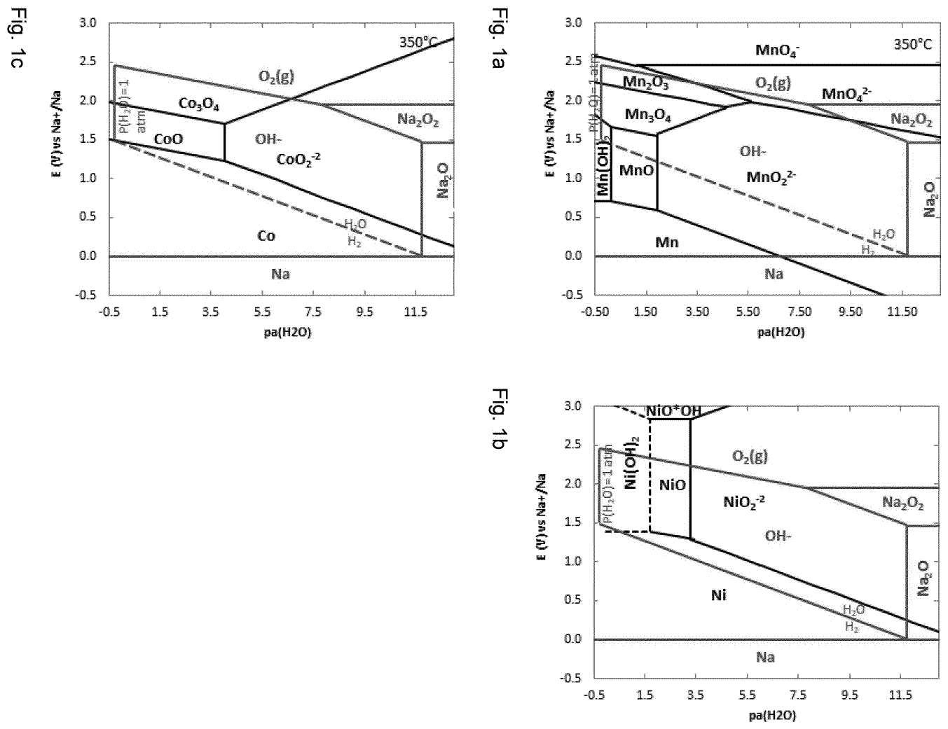

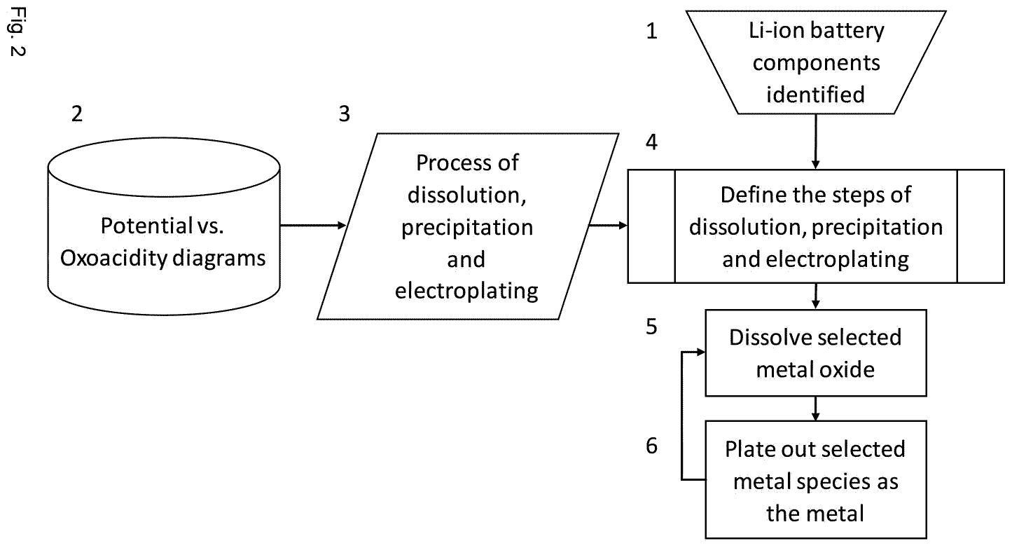

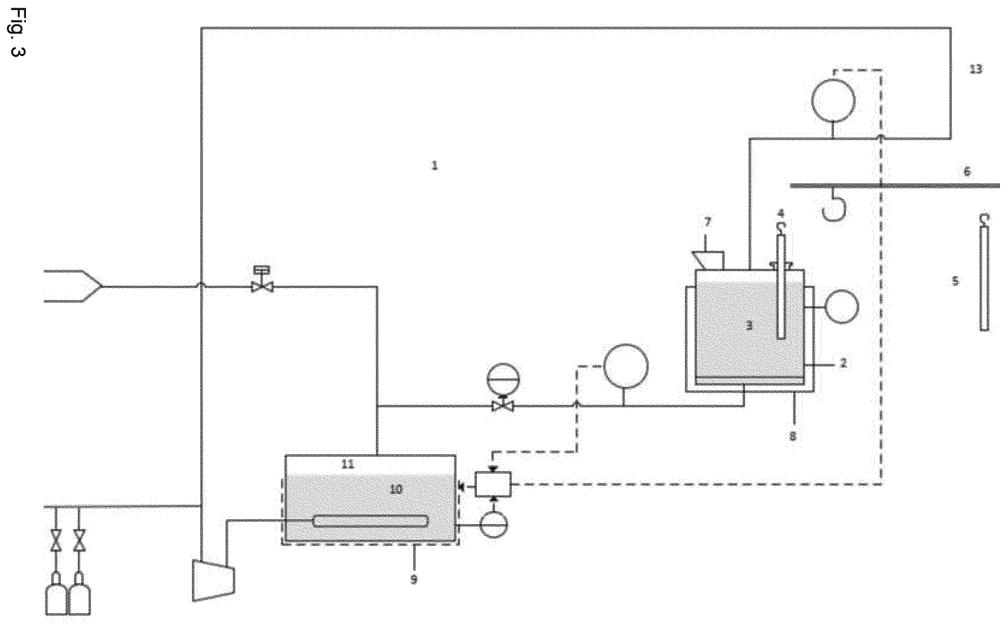

The “equilibrium redox potential vs. oxoacidity” diagram was calculated from thermodynamic data and presented as “E vs. pa (H₂O)” in FIG. 1c. This diagram represents the behaviour of Co and the oxides in a molten salt of NaOH at 500° C.

Calculated thermodynamic diagrams of Cobalt are seen in FIG. 1C for molten sodium hydroxide at 500° C. Dash lines represents the calculated thermodynamic diagram of molten sodium hydroxide.

After the establishment of the calculated diagram in FIG. 1c, several electrochemical measurements were carried out to verify the diagrams. The electrochemical measurements also allowed to obtain information for the parameters for the further process steps of recovering Co. The electrochemical measurements are further explained below.

### Recovery of Co

An alumina crucible was filled with 150 g of sodium hydroxide (pellets). Then, the crucible was placed in a reaction cell constituted of an Inconel 600 vessel (bottom) and a borosilicate lid (top). The NaOH was melted and kept at a temperature of 500° C. The system was always kept with an argon atmosphere.

The sodium hydroxide in the crucible was in communication with a water vapour reservoir for supplying water vapour to the hydroxide to adjust the oxoacidity of the hydroxide. The humidity of the cover gas determined the oxoacidity value in the hydroxide.

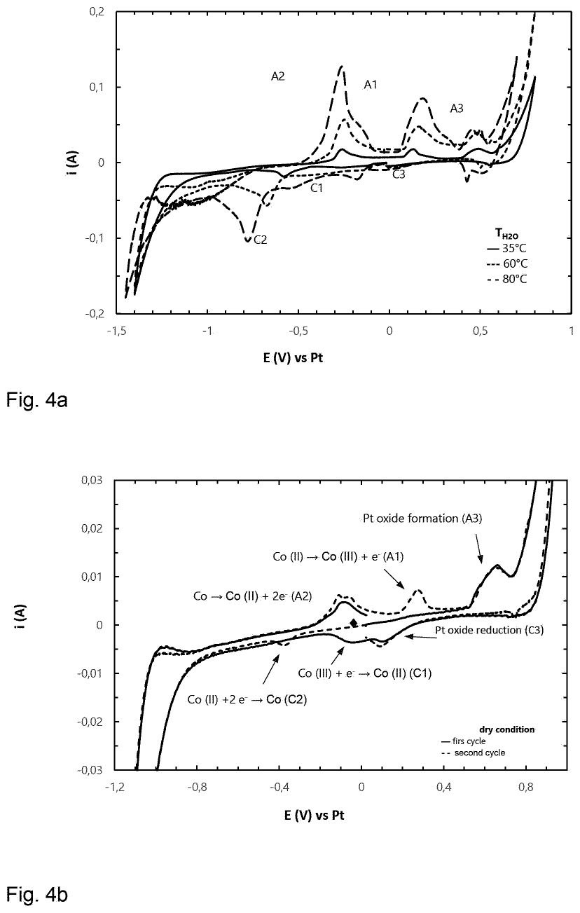

The targeted oxoacidity was determined from the following electrochemical measurements. Three Cyclic Voltammograms (CV) were recorded, one for each value of oxoacidity reflecting three temperatures of a water bath heating the oxoacidity agent H₂O, said temperature of the water bath being 35° C., 60° C. and 80° C. The differences in water bath temperature impacts in differences in humidity and thereby the content of the oxoacidity agent H₂O. The three CVs are seen FIG. 4a.

FIG. 4 shows Cyclic Voltammograms recorded in molten sodium hydroxide in presence of CoO in a wet (FIG. 4a) and dry (FIG. 4b) cover argon atmosphere at 500 deg C.

The humidity was chosen from the CV in FIG. 4a. It was decided to adjust the oxoacidity to a value based on the dissolution of Co shown as a prominent peak around −1.4 V with reference to a Pt reference. Other relevant chemical reactions taking place in a dry argon atmosphere during the CV are seen in FIG. 4b, and denoted A1, A2, C1 and C2. Some of these reactions also show up in the three CVs with water vapour (wet argon atmosphere) of FIG. 4a, one for each the value of the temperatures of the oxoacidity agent H₂O (water bath) being 35° C., 60° C. and 80° C.

The Cyclic Voltammograms in FIG. 4 were recorded in NaOH in presence of CoO with a Pt working electrode. The scan speed was 100 mV/s and the temperature of the NaOH was 500° C.

The oxoacidity of the NaOH was adjusted by supplying H₂O from the reservoir at a temperature of the water bath being 80° C. providing the targeted oxoacidity conditions.

2.18 g of CoO as a powder was contacted with the molten NaOH at 500° C. and kept at this temperature for 1 day. The concentration of CoO in NaOH was 0.194 mol per kg NaOH.

Thereafter the electrolysis was carried out applying a cathodic potential of −1.22V vs Pt for 1 hour (Q=510.16C) in order to electroplate the Co into its metallic form from the melt. Nickel-201 coupons were used as substrate for the electroplating carried out in molten NaOH at 500° C. using a wet argon cover atmosphere. The temperature of the water bath was 80° C.

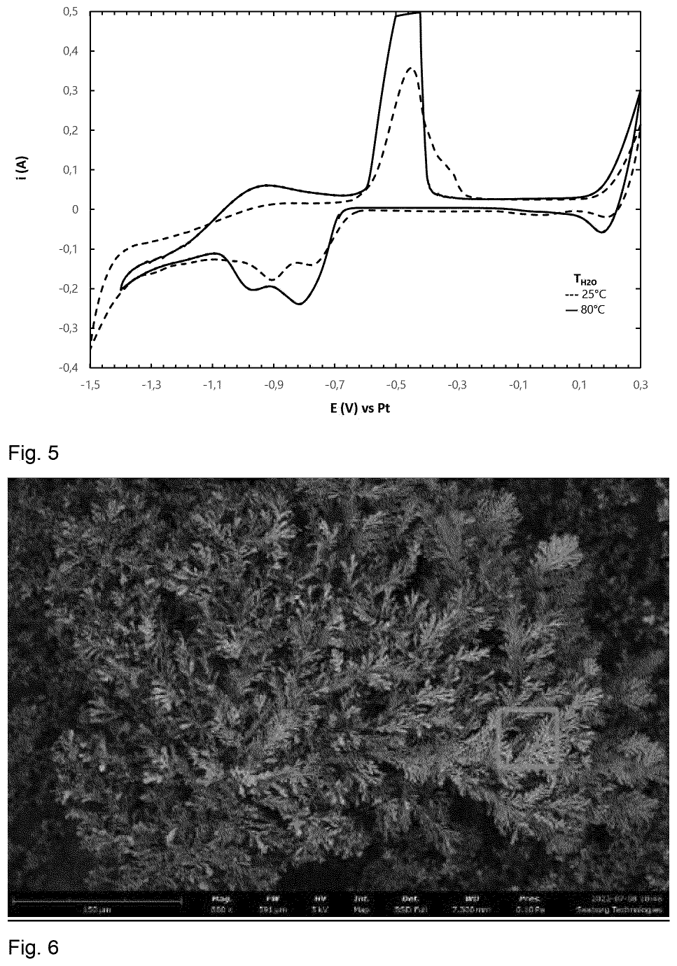

The value of the electrode potential of −1.22V vs Pt was found from voltammograms recorded in molten NaOH salt on a nickel 201 working electrode (coupon,) at 500° C. The CVs are seen FIG. 5 and were carried out before each electroplating process. Scan rate was 100 mV/s. Two different oxoacidity conditions were used represented by the temperature of the water bath fixed at 25 and 80° C., respectively.

FIG. 5 shows Cyclic Voltammograms recorded in molten NaOH in presence of CoO n a wet argon cover atmosphere at 500° C.

Energy dispersive x-ray spectroscopy (EDS) was carried out on the electroplated Co from the section shown in the scanning electron micrograph (SEM), 880x magnification of the electrode surface in FIG. 6, to determine the elements present.

The results of the EDS are shown in Table 1.

TABLE 1

| Element | Element | Element | Atomic | Weight |
|---|---|---|---|---|
| Number | Symbol | Name | Conc. | Conc. |
| 8 | O | Oxygen | 7.640 | 2.200 |
| 11 | Na | Sodium | 0.242 | 0.100 |
| 27 | Co | Cobalt | 92.118 | 97.700 |

The wt. % of the recovered metallic Cobalt was found to be 97.7%.

### EXAMPLE 2

In this example the recovery of several oxides is shown. The chosen material was LiNi_{0.33}Mn_{0.33}Co_{0.33}O₂ (Lithium Nickel Manganese Cobalt Oxide, NMC) as supplied from Sigma-Aldrich in a purity of 98%. The hydroxide used in the process was NaOH supplied by Fisher Scientific in a purity higher than 98%

The “equilibrium redox potential vs. oxoacidity” diagrams calculated from thermodynamic data used were the individual oxide-diagrams, like for example the Co-oxide diagram, the Ni-oxide diagram.

Several electrochemical measurements were carried out to verify the diagrams. The electrochemical measurements also allowed to obtain information for the parameters for the further process steps of recovering Co. The electrochemical measurements are further explained below.

### Recovery of MnO

An alumina crucible was filled with 150 g of sodium hydroxide (pellets). Then, the crucible was placed in a reaction cell constituted of an Inconel 600 vessel (bottom) and a borosilicate lid (top). The NaOH was melted and kept at a temperature of 500° C. The system was always kept with an argon atmosphere.

The sodium hydroxide in the crucible was in communication with a water vapour reservoir for supplying water vapour to the hydroxide to adjust the oxoacidity of the hydroxide. The humidity of the cover gas determined the oxoacidity value in the hydroxide.

A Cyclic Voltammograms (CV) was recorded for a temperature of the water bath being 80° C. The CV is seen FIG. 10.

It was decided to adjust the oxoacidity to a value based on the dissolution of Co shown as a prominent peak around −1.4 V with reference to a Pt reference. Other relevant chemical reactions taking place in a dry argon atmosphere during the CV are seen in FIG. 10.

The Cyclic Voltammogram in FIG. 10 was recorded in NaOH in presence of LiNi_{0.33}Mn_{0.33}Co_{0.33}O₂ with a Pt working electrode. The scan speed was 100 mV/s and the temperature of the NaOH was 500° C.

The oxoacidity of the NaOH was adjusted by supplying H₂O from the reservoir at a temperature of the water bath being 80° C. providing the targeted oxoacidity conditions.

2.56 g of LiNi_{0.33}Mn_{0.33}Co_{0.33}O₂ supplied as powder was contacted with the molten NaOH at 500° C. and kept at this temperature for 1 day. The concentration of LiNi_{0.33}Mn_{0.33}Co_{0.33}O₂ in NaOH was 0.199 mol per kg NaOH.

Thereafter the electrolysis was carried out applying a cathodic potential of −1.05V vs Pt for 1 hour (Q=128.43C) in order to electroplate the MnO from the melt. Nickel-201 coupons were used as substrate for the electroplating carried out in molten NaOH at 500° C. using a dry argon cover atmosphere.

The value of the electrode potential of −1.05 V vs Pt was found from voltammograms recorded in molten NaOH salt on a nickel 201 working electrode (wire, 0.33 cm² surface area exposed to the salt) at 500° C. The CVs are seen FIG. 10 and were carried out before each electroplating process. Scan rate was 100 mV/s.

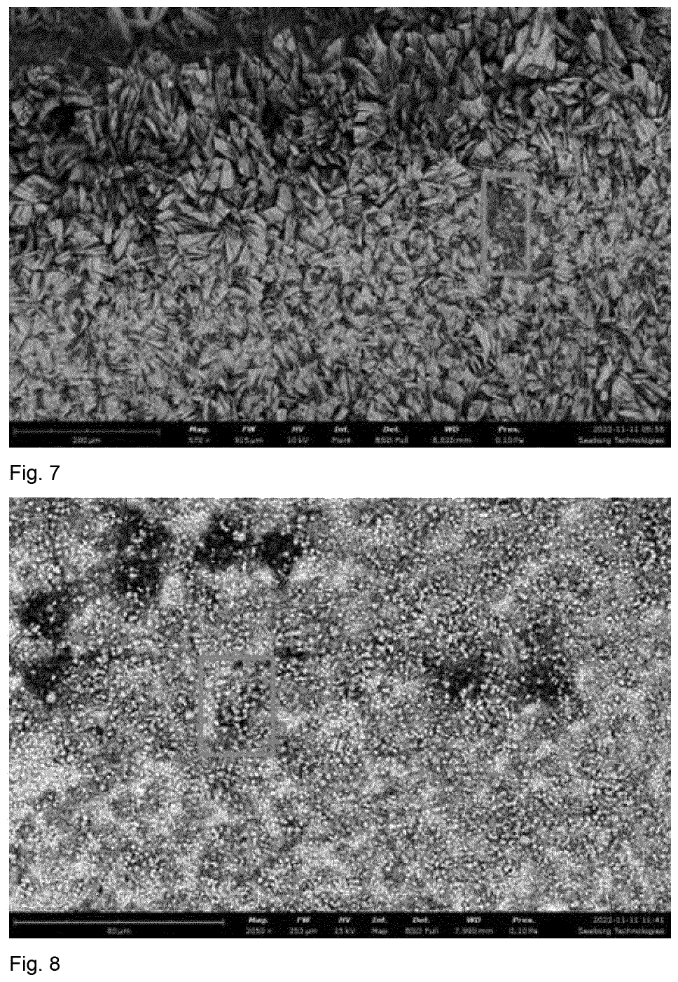

FIG. 10 shows Cyclic Voltammograms recorded in molten NaOH in presence of LiNi_{0.33}Mn_{0.33}Co_{0.33}O₂ in a wet argon cover atmosphere at 500° C. Energy dispersive x-ray spectroscopy (EDS) was carried out on the electroplated MnO from the section shown in the scanning electron micrograph (SEM), 570x magnification of the electrode surface in FIG. 7, to determine the elements present.

The results of the EDS are shown in Table 2

TABLE 2

| Element | Element | Element | Atomic | Weight |
|---|---|---|---|---|
| Number | Symbol | Name | Conc. | Conc. |
| 8 | O | Oxygen | 56.31 | 38.600 |
| 11 | Na | Sodium | 30.082 | 29.600 |
| 25 | Mn | Manganese | 13.487 | 31.700 |
| 27 | Co | Cobalt | 0 | 0 |
| 28 | Ni | Nickel | 0.040 | 1.000 |

Na is seen in EDS and is most likely due to NaOH not having been washed out fully before the analysis was done.

The wt. % of the recovered MnO was found to be approx. 70%.

### Recovery of CoNiO

In this example the recovery of CoNiO is shown.

Same conditions were used for Example 2 except for the electrolysis conditions below.

The electrolysis was carried out applying a cathodic potential of −0.05V vs Pt for 1 hour (Q=0.532C) in order to electroplate the CoNiO from the melt. Nickel-201 (wire, 0.33 cm² surface area exposed to the salt) were used as substrate for the electroplating carried out in molten NaOH at 500° C. using a dry argon cover atmosphere.

The value of the electrode potential of −0.05V vs Pt was found from voltammograms as above for MnO.

Energy dispersive x-ray spectroscopy (EDS) was carried out on the electroplated Co from the section shown in the scanning electron micrograph (SEM), 2550x magnification of the electrode surface in FIG. 8, to determine the elements present.

The results of the EDS are shown in Table 3.

TABLE 3

| Element | Element | Element | Atomic | Weight |
|---|---|---|---|---|
| Number | Symbol | Name | Conc. | Conc. |
| 8 | O | Oxygen | 55.853 | 32.200 |
| 11 | Na | Sodium | 19.910 | 16.500 |
| 25 | Mn | Manganese | 0 | 0 |
| 27 | Co | Cobalt | 5.133 | 10.900 |
| 28 | Ni | Nickel | 19.104 | 40.400 |

The wt. % of the recovered CoNiO amounts to approx. 83 wt. %

### Recovery of CoNiMnO

In this example the recovery of CoNiMnO is shown.

Same conditions were used for Example 2 except for the electrolysis conditions below.

Thereafter the electrolysis was carried out applying a cathodic potential of −1.38 V vs Pt for 1 hour (Q=66.56C) in order to electroplate the CoNiO from the melt. Nickel-201 (wire, 0.33 cm² surface area exposed to the salt) were used as substrate for the electroplating carried out in molten NaOH at 500° C. using a wet argon cover atmosphere. The temperature of the water bath was 80° C.

The value of the electrode potential of −1.38 V vs Pt was found from voltammograms as above for MnO.

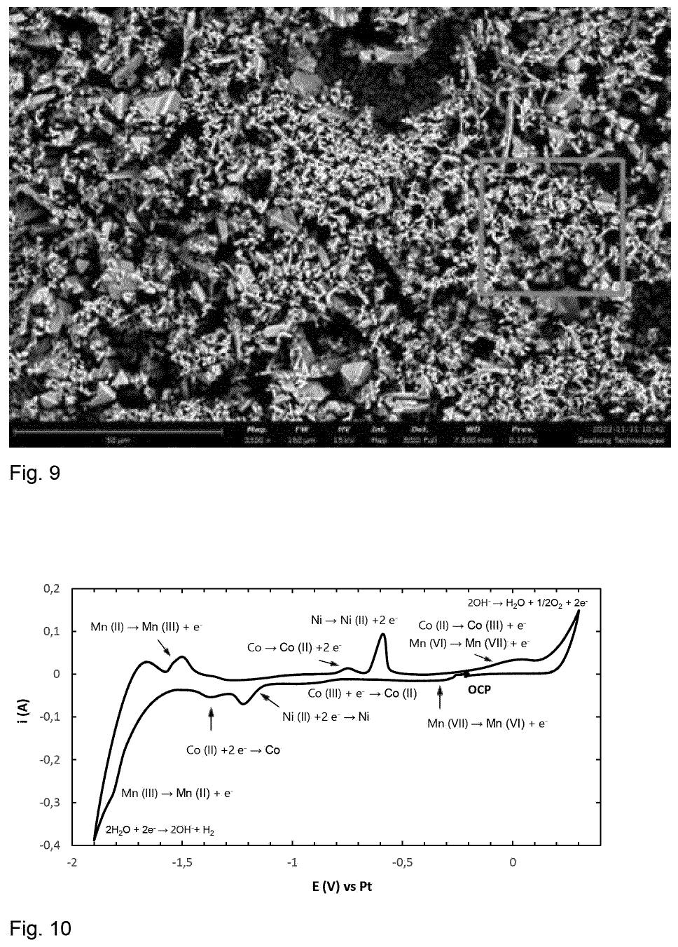

Energy dispersive x-ray spectroscopy (EDS) was carried out on the electroplated Co from the section shown in the scanning electron micrograph (SEM), 570x magnification of the electrode surface in FIG. 9, to determine the elements present.

The results of the EDS are shown in Table 4.

TABLE 4

| Element | Element | Element | Atomic | Weight |
|---|---|---|---|---|
| Number | Symbol | Name | Conc. | Conc. |
| 8 | O | Oxygen | 32.852 | 12.500 |
| 11 | Na | Sodium | 1.828 | 1.000 |
| 25 | Mn | Manganese | 52.965 | 69.200 |
| 27 | Co | Cobalt | 9.990 | 14.000 |
| 28 | Ni | Nickel | 2.364 | 3.300 |

The wt. % of the recovered CoNiMnO was approx. 99.0 wt. %

### Example 3

In this example the recovery of metallic Ni is shown. The chosen material to recover Ni from was NiO as supplied from Acros Organics in a purity of 97%. The hydroxide used in the process was NaOH supplied by Fisher Scientific in a purity higher than 98%

The Ni “equilibrium redox potential vs. oxoacidity” diagram calculated from thermodynamic data is shown in FIG. 1b.

This diagram represents the behaviour of Ni and the oxides in a molten salt of NaOH at 500° C. and served as a guideline for determining the values of the equilibrium redox potential value and the oxoacidity value at 600° C. where the recovery took place.

Calculated thermodynamic diagrams of Ni are seen in FIG. 1b for molten sodium hydroxide at 500° C. Dash lines represents the calculated thermodynamic diagram of molten sodium hydroxide.

After the establishment of the calculated diagram in FIG. 1b, several electrochemical measurements were carried out to verify the diagrams. The electrochemical measurements also allowed to obtain information for the parameters for the further process steps of recovering Ni.

### Recovery of Ni

120+1 g (approx. 3 mol) of ≥98% pure sodium hydroxide pellets were placed inside an alumina crucible inserted into a cell and argon gas inlet and the scrubber system outlet were plugged into the cell and the flow was turned on. After gradual heating steps, the temperature of the melt was (600±15)° C. 24 hours after dissolving 2.263 g NiO in the melt, an OCP (Open Circuit Potential) value stabilised to the value of 0.976 V with reference to SRE (the standard sodium electrode, Na/Na+), which, together with an estimated oxoacidity of pH₂O=6.

After performing the electrochemical measurements, argon was replaced with the hydrogenated cover atmosphere (5 vol. % H₂-95% Ar mixture) and the OCP dropped to a stable value of 0.834 V after 50 minutes. After 1 hour of hydrogen exposure (stage H₂ (1 h)), a CV measurement with a wire electrode set was taken, the result of which is given in FIG. 11.

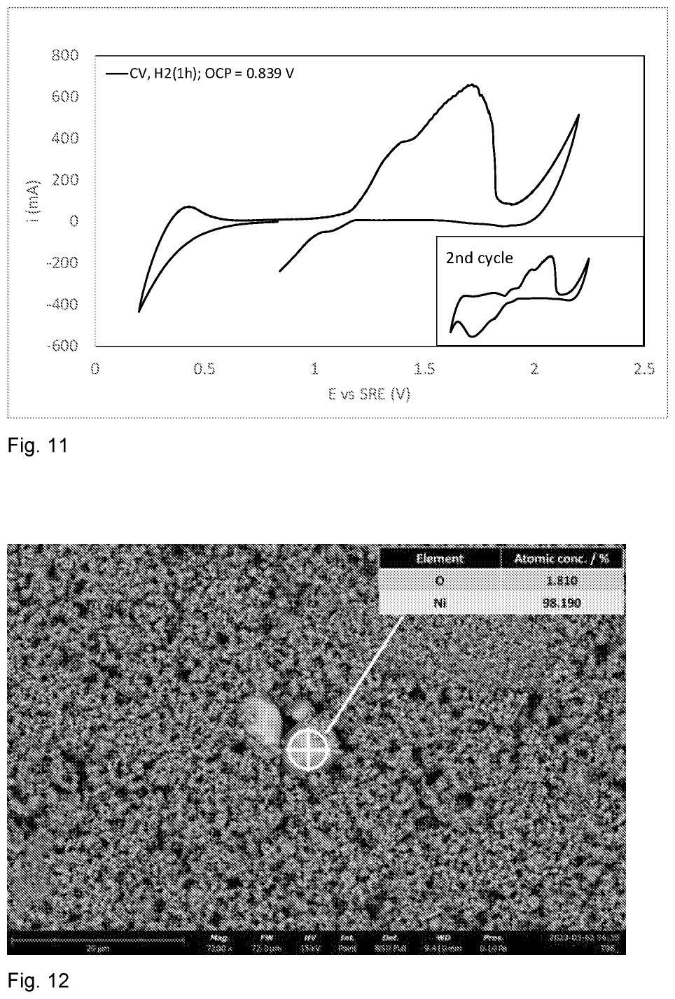

The total absence of the reduction peaks related to the existence of oxidized Ni species indicate a substantial deficiency of oxidised species in the immediate zone around the working electrode and suggests that the hydrogenated atmosphere reduced the Ni species to their metallic form. In fact, an SEM/EDS analysis of a slurry sample taken after 1 hour of hydrogen exposure showed small particles of metallic nickel already precipitating at the bottom of the crucible, see FIG. 12.

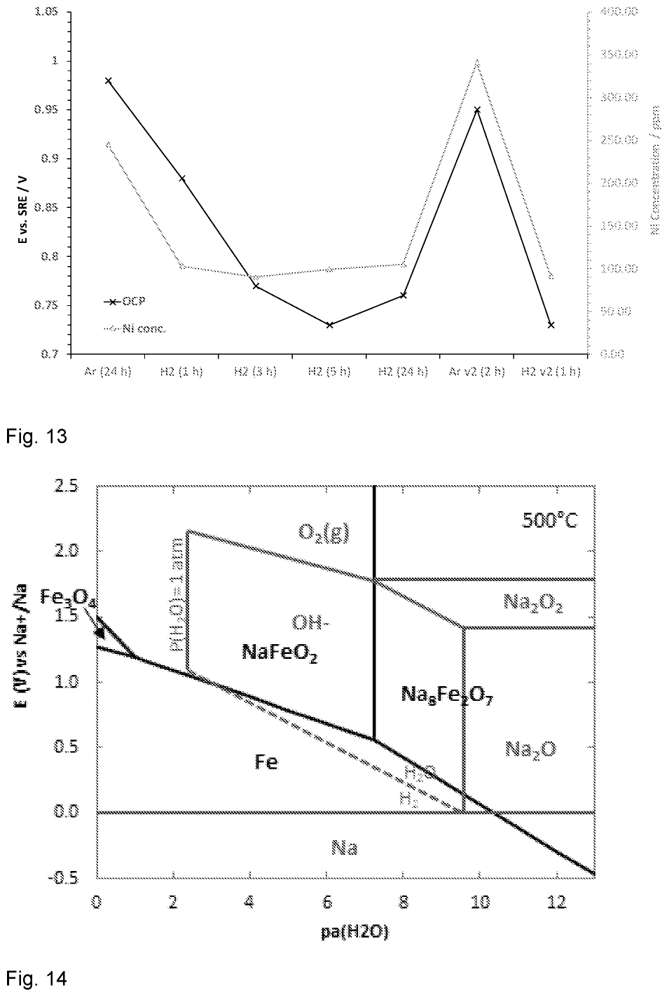

The change in OCP and in concentration of nickel in the melt with respect to the stages of the experiment is seen in FIG. 13.

Energy dispersive x-ray spectroscopy (EDS) was carried out on the precipitate shown in the scanning electron micrograph to determine the elements present.

The results of the EDS are shown in Table 5.

TABLE 5

| Element | Element | Element | Atomic | Weight |
|---|---|---|---|---|
| Number | Symbol | Name | Conc. | Conc. |
| 8 | O | Oxygen | 1.810 | 0.500 |
| 28 | Ni | Nickel | 98.190 | 99.500 |

The wt. % of the recovered metallic nickel was found to be 99.5%.

### EXAMPLE 4

In this example the recovery of metallic Fe is illustrated. The chosen material to recover Fe from was iron (III) oxide (Fe₂O₃) as supplied from Acros Organics with a purity of 96%. The hydroxide used in the process was NaOH supplied by Fisher Scientific in a purity higher than 98%.

The thermodynamic diagram used was calculated from values taken for Fe in NaOH at 500° C. from HSC 10.0, see FIG. 14.

This diagram can be used to understand the behaviour of Fe and the oxides in a molten salt of NaOH and served as a guideline for determining the values of the equilibrium redox potential value and the oxoacidity value at 600° C. where the recovery took place.

Calculated thermodynamic diagrams of Fe are seen in FIG. 14 for molten sodium hydroxide at 500° C. Dashed lines represent the calculated thermodynamic diagram of molten sodium hydroxide.

After the establishment of the calculated diagram in FIG. 14, several electrochemical measurements were carried out to verify the diagrams. The electrochemical measurements also allowed to obtain information for the parameters for the further process steps of recovering Fe.

### Recovery of Fe

120±1 g (approx. 3 mol) of ≥98% pure sodium hydroxide pellets were placed inside an alumina crucible inserted into a cell and argon gas inlet and the scrubber system outlet were plugged into the cell and the flow was turned on. After gradual heating steps, the temperature of the melt was (600±15)° C. 24 hours after dissolving 2.374 g Fe₂O₃ in the melt, an OCP (Open

Circuit Potential) value stabilised to the value of 0.887 V with reference to SRE (the standard sodium electrode, Na/Na+), which, together with an estimated oxoacidity of pH₂O=4.5.

After performing the electrochemical measurements, argon was replaced with the hydrogenated cover atmosphere (5% H₂-95% Ar mixture).

After imposing the hydrogenated atmosphere onto the system, the OCP experienced the sharpest decline within the first hour to the value of 0.715 V, after which the OCP experienced a slow progressive reduction in OCP to reach 0.682 V at the 24-hour mark.

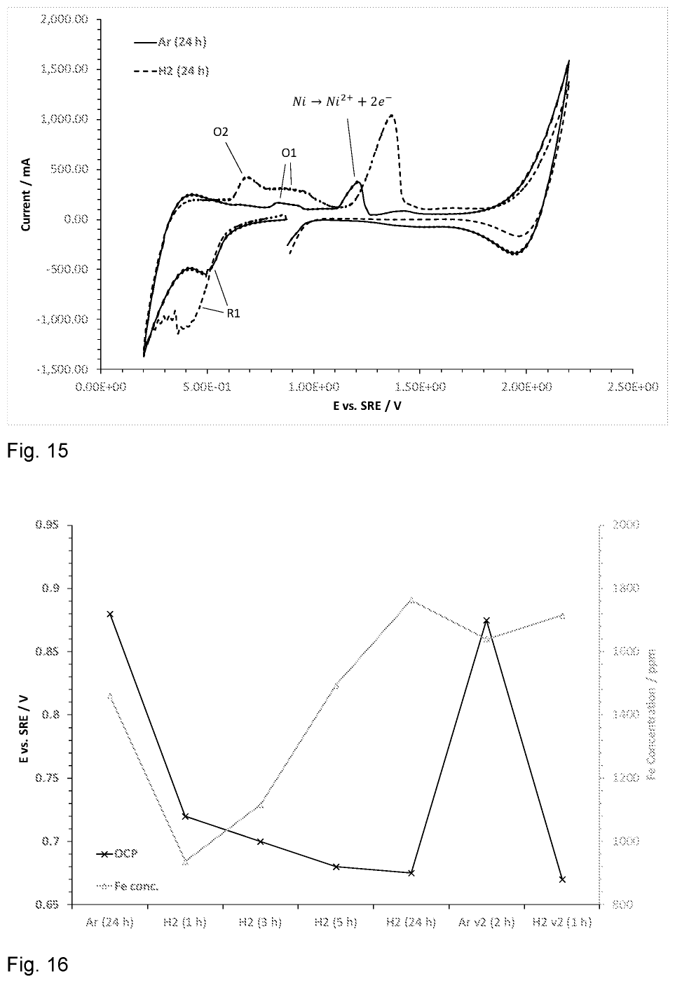

After the 1 hour of hydrogen exposure (stage H2 (1 h)), a CV measurement with the wire electrode set was taken, the result of which is given in FIG. 15.

The R1 peak from the CV in FIG. 15 had been identified in CV measurements to be the reaction: R1: Fe(III)+3e⁻→Fe.

The change in OCP and in concentration of iron in the melt with respect of the stages of the experiment is seen in FIG. 16.

The R1 peak, assigned to the reduction of Fe (III) to Fe (0), occurred at potential of approx. 0.5 V with its onset at approx. 0.6 V. Using a H₂ pressure value larger than provided by a hydrogenated cover atmosphere (5% H₂-95% Ar mixture) would result in shifting the OCP to potentials for example a value of 0.5 V and would result in the recovery of Fe.

Such a H₂ pressure value provided by the hydrogenated cover atmosphere is for example a 10% H₂-90% Ar mixture.

In addition, an increase in oxoacidity of the melt would be beneficial as higher water contents will shift the metallic iron stability window to higher potentials, hence a wet hydrogenated cover atmosphere will result in recovery of metallic iron (Fe(0)) at the same potentials compared to dry hydrogen atmosphere.

1. A method of recovering at least one metal species from a raw material comprising:
providing a molten salt comprising at least one metal hydroxide
providing at least one oxoacidity agent
a) setting the oxoacidity of the molten salt with the at least one oxoacidity agent to an oxoacidity value to dissolve at least one metal species in the molten salt
contacting the raw material with the molten salt
performing at least one of the steps b) and c):
b) setting an electrical potential of the molten salt to recover a first metal species to a first metal or first metal oxide, and
c) adjusting the oxoacidity of the molten salt with the at least one oxoacidity agent to precipitate a first metal oxide.

2. A method according to claim 1 wherein the electrical potential of the molten salt is set by setting the electrical potential using a redox agent, and/or setting the electrical potential with an applied voltage between an anode and a cathode in the molten salt, said step of setting the electrical potential is carried out after contacting the raw material with the molten salt.

3. A method according to claim 1, wherein the electrical potential of the molten salt is set by setting the electrical potential using a redox agent being an H₂ containing gas in contact with the molten salt.

4. A method according to claim 3 wherein the electrical potential is lowered with a voltage in the interval from 0.05 to 0.75 V.

5. A method according to claim 3 wherein the electrical potential is lowered with a voltage in the interval from 0.10 to 0.4 V.

6. A method according to claim 3 wherein the electrical potential is lowered with a voltage in the interval from 0.15 to 0.3 V.

7. A method according to claim 1 wherein the raw material comprises at least one metal oxide compound.

8. A method according to claim 1 wherein the raw material comprises at least one Co oxide compound.

9. A method according to claim 1, wherein the oxoacidity is set to dissolve the raw material into a first metal species; an electrical potential is applied to reduce the first metal species to a first metal, thereafter the oxoacidity is set to dissolve the raw material into a second metal species; and an electrical potential is applied to reduce the second metal species to a second metal.

10. A method according claim 9, wherein the first metal is Mn and the at least one further metal is selected from the group consisting of Al and transition metals.

11. A method according claim 10, wherein the at least one or more further metal is selected from the group consisting of Al and Fe, Co, and Ni.

12. A method according to claim 1 wherein the oxoacidity is set to dissolve a first, a second and a third metal species, and the oxoacidity is adjusted to precipitate the first metal species as a first metal oxide.

13. A method according to claim 12 where the first metal species is a Co species and the at least one further metal species is a transition metal species.

14. A method according to claim 13 where the at least one further metal species is a transition metal species selected from the group of Fe, Mn, and Ni.

15. A method according to claim 1, where the electrical potential applied to recover the first metal species as a first metal, or first metal oxide is carried out in an electrodeposition process comprising:
applying the electrical potential to at least two electrodes submerged in the molten salt of a metal hydroxide comprising the metal species,
the first metal or first metal oxide being deposited and recovered from the electrode forming the cathode.

16. A method according to claim 1, wherein the oxoacidity agent is at least one compound selected from the group of OH⁻, O²⁻, and H₂O.

17. A method according to claim 1, where the metal hydroxide is at least one hydroxide selected from the group of NaOH, KOH, LiOH and RbOH.

18. A method according to claim 1, where the raw material is a waste lithium-ion battery material comprising an electrode material.

19. A method according to claim 1, where the raw material is a waste lithium-ion battery material comprising a cathode material.

20. A method according to claim 1, wherein the raw material comprises at least one waste lithium-ion battery material based on oxides selected from the group consisting of:
Lithium Nickel Manganese Cobalt Oxide (NMC, LiNiₓMn_{y}Co_{z}O₂),
Lithium Nickel Cobalt Aluminium Oxide (NCA, LiNiCoAlO₂),
Lithium Manganese Oxide (LMO, LiMn₂O₄),
Lithium Iron Phosphate (LFP, LiFePO₄),
Lithium Cobalt Oxide (LCO, LiCoO₂).

21. A method according to claim 1, where the concentration of the dissolved at least one metal species is in the interval of 0.1 to 10 mol/kg molten salt.

22. A method according to claim 1, where the concentration of the dissolved at least one metal species is in the interval of 0.2 to 7 mol/kg molten salt.

23. A method according to claim 1, where the concentration of the dissolved at least one metal species is in the interval of 0.4 to 5 mol/kg molten salt.

24. A method according to claim 1, where the concentration of the dissolved at least one metal species is in the interval of 0.8 to 3 mol/kg molten salt.

25. A system for recovering at least one metal species from a raw material comprising:
a container comprising a molten salt of at least one metal hydroxide
a reservoir comprising water vapour, said reservoir being in communication with the bottom section of the container and said bottom section comprising a sparger
at least two electrodes in contact with the molten salt of at least one metal hydroxide.

26. A system according to claim 25, wherein the system is for use in a method of recovering at least one metal species from a raw material comprising:
providing a molten salt comprising at least one metal hydroxide
providing at least one oxoacidity agent
a) setting the oxoacidity of the molten salt with the at least one oxoacidity agent to an oxoacidity value to dissolve at least one metal species in the molten salt
contacting the raw material with the molten salt
performing at least one of the steps b) and c);
b) setting an electrical potential of the molten salt to recover a first metal species to a first metal or first metal oxide, and
c) adjusting the oxoacidity of the molten salt with the at least one oxoacidity agent to precipitate a first metal oxide.

27. A system according to claim 25, wherein the raw material is a waste lithium-ion battery material.

28. A system according to claim 25 comprising an inventory of cathodes.

29. A system according to claim 25, wherein the sparger is adapted to sparging a gas comprising a redox agent.

30. A system according to claim 29, wherein the redox agent is H₂.

31. A system according to claim 25, wherein the molten salt comprises a material for surface promoted recovery for precipitation of the metal species.

32. A method according to claim 1, wherein the oxoacidity agents is provided as a reservoir of at least one oxoacidity agent being in communication with the molten salt

33. A method according to claim 1 further comprising the step of performing, for at least one further metal species, the method step a) and/or performing at least one of the method steps b) and c)

34. A method according to claim 9, wherein the oxoacidity is thereafter set to dissolve the raw material into a third metal species; and an electrical potential is applied to reduce the third metal species to a third metal

35. A method according to claim 12, wherein the oxoacidity is thereafter adjusted to precipitate the second metal species as a second metal oxide.

36. A method according to claim 35, wherein the oxoacidity is thereafter adjusted to precipitate the third metal species as a third metal oxide
